(19) United States
(12) Patent Application Publication
(10) Pub. No.: US 2006/0175469 A1
(43) Pub. Date: Aug. 10, 2006

(54) Wing of aircraft

(75) Inventors: Wlodzimierz Gnarowski, Warszawa (PL); Wojciech Kania, Warszawa (PL); Anna Gnarowska, Warszawa (PL)

Correspondence Address: Welsh & Katz, Ltd., 120 South Riverside Plaza, 22nd Floor, Chicago, IL, 60606-3945, US

(73) Assignee: Instyut Lotnictwa, Poland (PL)

(21) Appl. No.: 10/564,168

(22) PCT Filed: Jul. 9, 2004
(86) PCT No.: PCT/PL04/00054

§ 371 Date: Jan. 10, 2006

(30) Foreign Application Priority Data
Jul. 11, 2003 (PL) P.361221

(51) Int. Cl. B64C 3/50

(52) U.S. Cl. 244/214; 244/215

(57) ABSTRACT

Wing of aircraft with slats (1) and one-slotted sliding flaps with driving gear, is characterized by two movable segments in each flap: fore box (2) and main flap (3), which are connected by spring actuators (4) to each other and move on rolls (5) along guides (6) of radius (R) bigger than a half chord (c) of wing airfoil section. The flap segments are located in chamber (7), which composes a sector of cylinder wall with thickness limited by both upper flow-surface of wing box (8) and closing panel (9) situated at the bottom of this box. Fore box of flap is situated in each of its position at least partially within the chamber, whereas the mail flap is situated in its various positions at least partially within the chamber or fully beyond it. Driving gear of each flap is located along wing span and completely hidden in transversal outline of the wing.

### CROSS REFERENCES TO RELATED APPLICATIONS

This application is a National Phase Application based upon priority International PCT Patent Application No. PCT/PL2004/000054 filed Jul. 9, 2004, International Publication No. WO 2005/005251 A1 published Jan. 20, 2005 which is based upon priority Poland Patent Application P.361221 filed Jul. 11, 2003.

### BACKGROUND OF THE INVENTION

Subject matter of an invention is wing of aircraft with slats and segmented one-slotted sliding flaps with driving gear.

The wing of such type, for example from patent description DE 748146, has got a flap, which consists of placed in wing chamber two movable segments. They are set on movable guides composing an unit of rails, driven by toothed wheels. The segments shift to the back, causing increase of wing airfoil extension. At terminal position one of the segments closes a rear outlet of the chamber and the second one—fixed rotationally to guide and completely protruded beyond the chamber—incline downwards forming a slot between the segments. A dimension of the slot is defined by length of cable, supporting the rotated segment.

### BRIEF SUMMARY OF THE INVENTION

According to the invention wing of aircraft with slats and segmented one-slotted sliding flaps consisting of placed in wing chamber two movable segments: fore box and main flap connected by spring actuators to each other and moving on rolls along curved guides this way, that fore box is situated in each of its positions at least partially within the chamber, and the main flap is situated in its various positions at least partially within the chamber or fully beyond it, is characterized in that wing chamber composes a sector of cylinder ring with thickness limited by both a tangent to wing box surface at its top rear point and closing panel, situated at the bottom of this box, and fore box has got outline with both upper and bottom lines strictly fitting to shape of chamber. From aft spar of wing direction this outline is open so, that it comprises elements of driving gear of flap. The guides, built as single C-shaped rails and immovably attached to wing, are formed by means forcing mutual position of fore box and main flap in each phase of their movement, in such a way, that during protruding of the wing flap, increase of both extension and chamber of the wing airfoil follows in continuous way, and rear wall of fore box composes with attack surface of main flap a continuously changing slot, convergent in aft edge of wing direction. Radius of curvature of guides is bigger than a half chord of wing airfoil section and considerably decreases on their end.

Driving gear of each flap is located along wing span and completely hidden in transversal outline of the wing.

A solution according to the invention brings profitable effects, increasing wing lift throughout three phases of flight—take-off, cruising and landing of aircraft. At cruising phase, in range of small angles of flap displacement, it affords possibilities for un-slotted increase of wing airfoil camber. At both take-off and landing phases an increase of flap displacement with simultaneous extension of wing airfoil allows to obtain optimal airfoil with slotted flow in these conditions, preventing premature flow separation on upper wall of an airfoil. For each phase of flight, also owing to panel closing chamber, there is decreased flow drag on bottom wall of an airfoil.

As opposed to prior art, the solution according to the invention is characterized by smooth change of both camber and extension of the wing airfoil and also smooth change of slot dimension. It gives following potentialities:
at cruise configuration of wing airfoil (both chamber and extension without slot) there is possible the change of aerodynamic angle of attack of wing in relation to fuselage according to current mass of aircraft, what minimises aerodynamic drag of aircraft in given conditions. At high cruise speed the change of both camber and extension of rear part of wing airfoil, modificating pressure distribution on airfoil, makes possible a mitigation of shock wave crisis occurrence on the wing:
at take-off configuration of wing airfoil (both camber and extension with slot) there is possible to obtain optimal lift coefficient of wing and optimal lift/drag ratio of aircraft, which has an effect on increase of second segment of aircraft climb gradient and on decrease of BFL factor (take-off Balanced Field Length according to FAR 25 definition):
at landing configuration of wing airfoil (both camber and extension with slot) there is possible both to obtain large lift coefficients, which have direct influence on landing speed and to reduce lift/drag ratio of aircraft in order to attain steeper glide path of aircraft on landing.

A location of elements of wing flap driving gear within the outline of fore box enables an application of this solution for wings of various airfoil shapes, and fastening of guides immovably simplifies highly their structure.

A location of driving gear of each wing flap along wing span so, that it is completely hidden transversal outline of the wing, leads to a decrease of wing drag, and as a consequence whole aircraft, of about 1.5%.

A wing of aircraft may be equipped, along span of trailing edge, with greater number of flaps (e.g. over a dozen). It allows to obtain following utility characteristics of wing:
high coefficient of lift.
optimal distribution of both circulation and lift along span, according to flight phase, due to an analysis of both induced drag and weight of structure.
elimination of conventional lateral control in form of ailerons or flaperons.

A more detailed description of the invention is provided in the following description and appended claims taken in conjunction with the accompanying drawings.

### BRIEF DESCRIPITION OF THE DRAWINGS

The object of the invention is shown as exemplary embodiment in drawing, in which

FIG. 1 presents wing airfoil section according to the invention, with indication of both guides radius and airfoil chord, and following figures present the same airfoil section:

FIG. 2—in cruising phase for smooth configuration.

FIG. 3—in cruising phase for increased camber configuration.

FIG. 4—in take-off phase.

FIG. 5—in landing phase, while

FIG. 6 presents segment of wing, according to the invention, with built in driving gear, at top view, in cruising phase.

FIG. 7—cross section of this segment.

FIG. 8—the same segment at top view, in landing phase.

FIG. 9—cross section of this segment.

FIG. 10 presents driving gear of flap with its main components, at top half-view.

FIG. 11—section of this gear marked as A-A on FIG. 10, and

FIG. 12—section of this gear marked as B-B on FIG. 10.

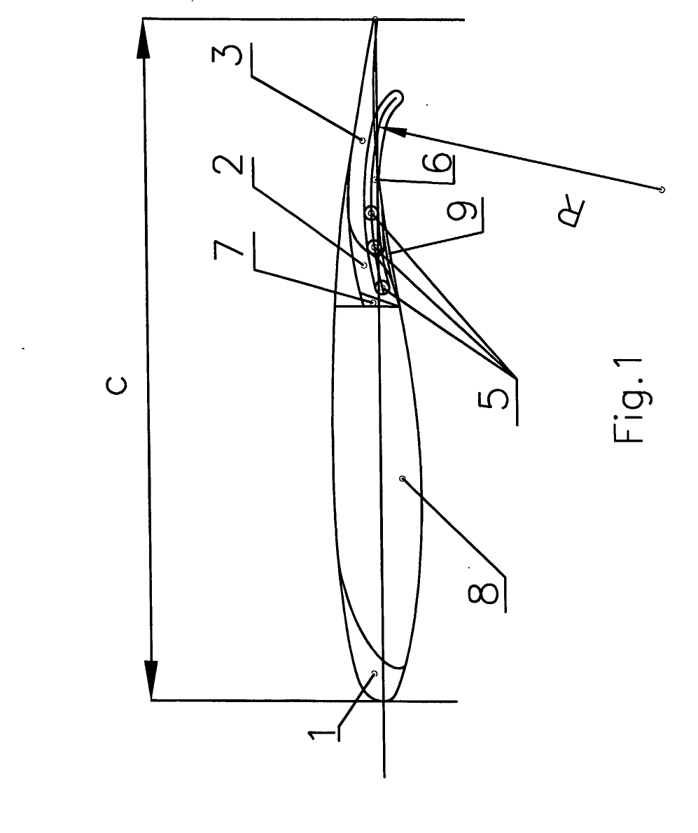

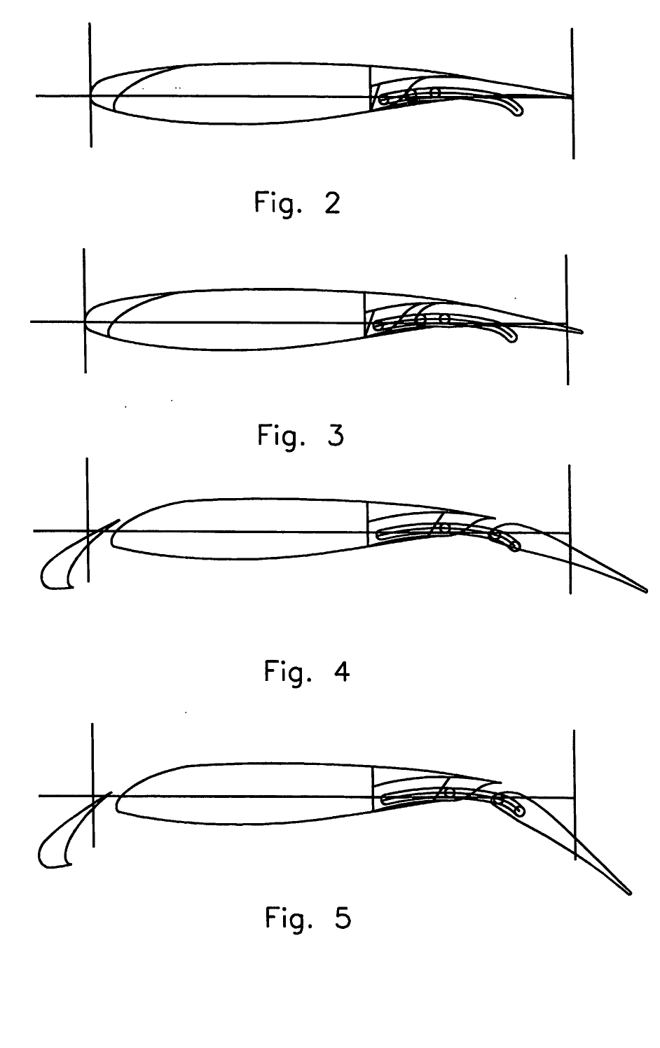

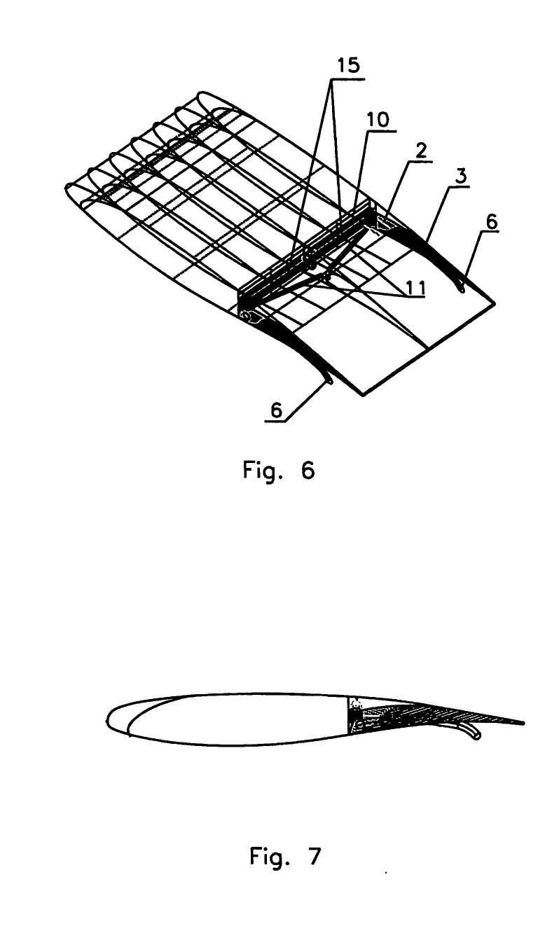

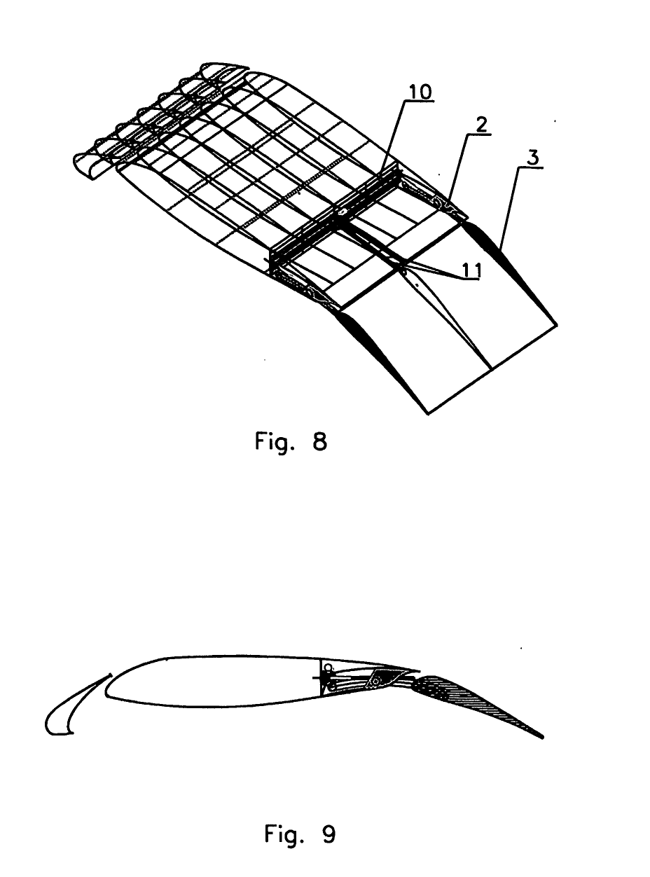

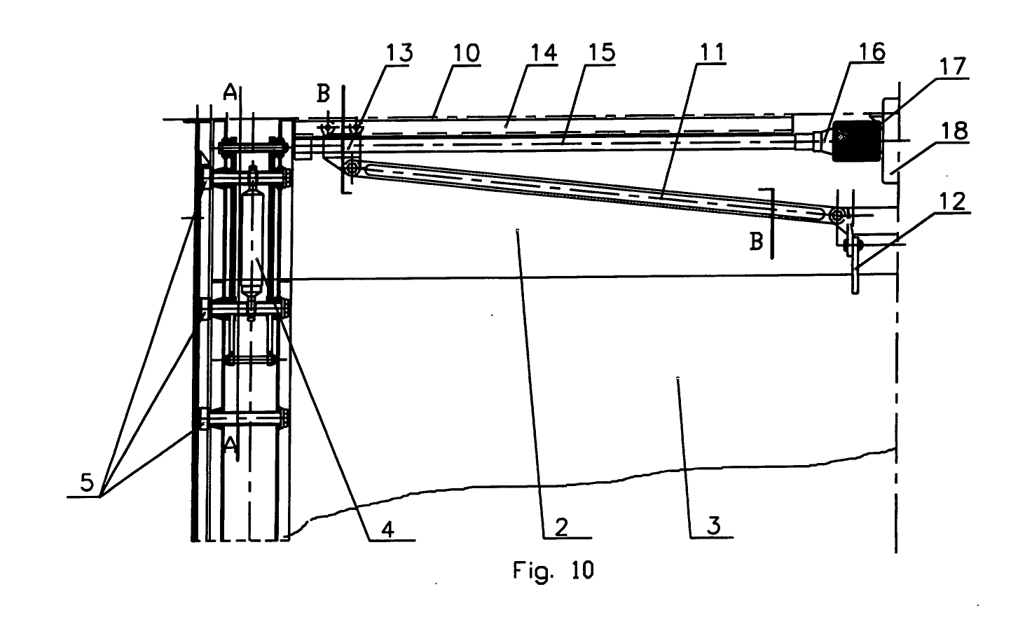

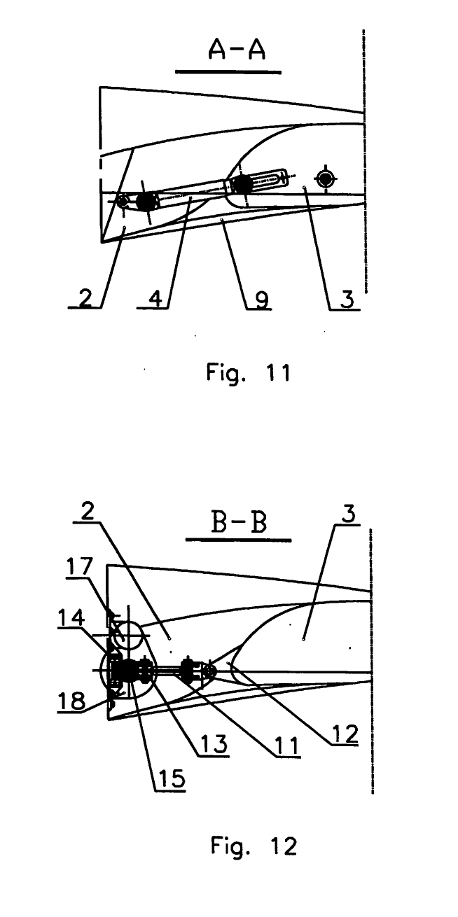

### DETAILED DESCRIPTION OF THE INVENTION

The following is a detailed description and explanation of the preferred embodiment and best mode for embodying the invention.

Wing of aircraft is equipped with slats 1 and segmented sliding flaps. Two movable segments in each flap: fore box 2 and main flap 3, are connected by spring actuators 4 to each other. The segments move on rolls 5 along guides 6 built as single C-shaped rails and immovably attached to wing. Radius R of curvature of guides is bigger than a half chord c of wing airfoil section and considerably decreases on their end. The segments are located in chamber 7, which composes a sector of cylinder ring with thickness limited by both a tangent to wing box 8 surface at its top rear point and closing panel 9 situated at the bottom of this box. The fore box 2 has got outline with both upper and bottom lines strictly fitting to shape of chamber 7. From aft spar of wing direction this outline is open so, that it comprises elements of driving gear of flap.

The driving gear of each flap is located along wing span and completely hidden in transversal outline of the wing. It is fixed on rear plane 10 of wing box 8, perpendicular to airfoil section chord c.

Main flap 3 is moved forward by pusher 11, connected on one end with flap ferrule 12, and on other one with trolley 13 sliding along guide 14 on screw 15 powered through Cardan joint 16, by hydraulic engine 17 with transmission gear 18. A motion of fore box 2 results from its connection with main flap 3 by spring actuators 4.

During an aircraft cruising phase the solution according to the invention gives possibility to move main flap 3 forward so, that the wing airfoil both cambers slightly and extends a little: at the same time fore box 2 is totally situated within chamber 7, and the main flap remains at partial contact with the chamber. During aircraft take-off and landing phases main flap 3 goes fully protruded beyond chamber 7: at the same time fore box 2 partially contacts with the camber of the wing airfoil, owing to suitable shaping of guides 6, follows in continuous way, and rear wall of fore box 2 composes with attack surface of main flap 3 a continuously changing slot, convergent in aft edge of wing direction.

Although embodiments of the invention have been shown and described it is to be understood that various modificating substitutions and rearrangements of parts, elements, components, and equipment can be made by those skilled in the art without departing from the novel spirit and scope of the invention.

1. Wing of aircraft with slats and segmented one-slotted sliding flaps consisting of placed in wing chamber two movable segments: fore box and main flap connected by spring actuators to each other and moving on rolls along curved guides this way, that fore box is situated in each of its positions at least partially within the chamber, and the main flap is situated in its various positions at least partially within the chamber or fully beyond it, characterized in that wing chamber (7) composes a sector of cylinder ring with thickness limited by both a tangent to wing box (8) surface at its top rear point and closing panel (9), situated at the bottom of this box, and fore box (2) has got outline with both upper and bottom lines strictly fitting to shape of chamber (7), at the same time from aft spar of wing direction this outline is open so, that it comprises elements of driving gear of flap, whereas guides (6), built as single C-shaped rails and immovably attached to wing, are formed by means forcing mutual position of fore box (2) and main flap (3) in each phase of their movement, in such a way, that during protruding of the wing flap, increase of both extension and camber of the wing airfoil follows in continuous way, and rear wall of fore box (2) composes with attack surface of main flap (3) a continuously changing slot, convergent in aft edge of wing direction.

2. Wing of aircraft as claimed in claim 1, characterized in that radius (R) of curvature of guides (6) is bigger than a half chord (c) of wing airfoil section and considerably decreases on their end.
